(19) United States
(12) Patent Application Publication
(10) Pub. No.: US 2007/0014416 A1
(43) Pub. Date: Jan. 18, 2007

(54) System and method for protecting against dictionary attacks on password-protected TPM keys

(76) Inventors: David Rivera, Durham, NC (US); David Carroll Challener, Raleigh, NC (US); James Patrick Hoff, Raleigh, NC (US)

Correspondence Address: ROGITZ & ASSOCIATES, 750 B STREET, SUITE 3120, SAN DIEGO, CA, 92101, US

(21) Appl. No.: 11/183,116

(22) Filed: Jul. 15, 2005

(51) Int. Cl. H04L 9/00

(52) U.S. Cl. 380/286

(57) ABSTRACT

A computer system that may include a trusted platform module (TPM) along with a processor hashes a user-supplied password for a predetermined time period that is selected to render infeasible a dictionary attack on the password. The results of the hash are used to render an AES key, which is used to encrypt an RSA key. The encrypted RSA key along with the total number of hash cycles that were used is stored and the RSA key is provided to the TPM as a security key. In the event that the RSA key in the TPM must be recovered, the encrypted stored version is decrypted with an AES key that is generated based on the user inputting the same password and hashing the password for the stored number of cycles.

### I. FIELD OF THE INVENTION

The present invention relates generally to securely storing backup encryption keys.

### II. BACKGROUND OF THE INVENTION

Computer users wishing to implement a security solution are constantly faced with the tradeoff between convenience and security, because more security generally means more difficulty in using a system. A solution based on a Trusted Platform Module (TPM), or security chip, must contend with this tradeoff.

In the case of a TPM, the most secure usage of keys generated for use with the TPM would involve generating the keys within the TPM chip, and not allowing the keys to migrate to other systems. While this offers security because the keys are useless to a hacker who might attempt to crack the keys for use on another system, it also requires that no backup copies of the keys can be kept. As understood herein, this has the inconvenient drawback that if the user's motherboard is replaced pursuant to, e.g., a hardware failure, the keys are rendered worthless and new keys must be regenerated, a costly penalty to customers who have paid for digital certificates. Also, any security credentials protected with the keys, such as stored passwords and encrypted files, would no longer be accessible.

Not surprisingly, in light of the above a more convenient solution is desirable to allow for the recovery of keys in the event of a hardware failure. Moreover, as understood herein a solution is desirable that also allows users to move their keys from one system to another, to enable large enterprise customers, for instance, to permit their users to roam from system to system and have their security keys available to them on the systems to which they roam. Nonetheless, the present invention recognizes that the security of user keys must be maintained.

As further recognized by the present invention, facilitating the recovery of users' security keys by keeping copies of the keys and protecting the copies with a master administrator key suffers from both convenience and security drawbacks. Specifically, the presence of an administrator inconveniently is required for key restoration, and, if the master key is ever lost or compromised, the integrity of all keys in the environment likewise is compromised. Alternatively using bare passwords to protect copies of the keys similarly is less than optimal, because passwords are susceptible to being defeated by dictionary attacks. With the critical recognitions above in mind, the invention herein is provided.

### SUMMARY OF THE INVENTION

A method is disclosed for providing for secure storage of a security key, which may be, without limitation, an RSA key intended for use in a trusted platform module (TPM). The method includes performing a one-way function such as hashing on a user-provided password for at least a time period to generate a result, and then using the result to generate a password-derived key such as, without limitation, an AES key. The security key is encrypted with the password-derived key to render an encrypted key, which is stored, with the unencrypted security key being provided to, e.g., the TPM. The time period may be a predetermined time period that has a length which is sufficient to render a dictionary attack to discover the password infeasible.

In non-limiting implementations the total number “M” of hash cycles that were executed on the password is also stored. Consequently, the RSA key can be recovered by providing the password, retrieving the number “M” of hash cycles, and hashing the password “M” times to produce the password-derived key. The encrypted key, retrieved from memory, is decrypted using the password-derived key to render a recovered version of the security (e.g., RSA) key.

In another aspect, a computer system includes a memory and a trusted platform module (TPM). The memory is not part of the TPM. A system processor executes logic that includes hashing a user-supplied password for at least a predetermined time period that is selected to render infeasible a dictionary attack on the password. The logic also includes using information derived from the results of the hashing to encrypt a TPM key to render an encrypted key, which is stored in the memory, with the TPM key being provided to the TPM.

In yet another aspect, a computer system includes means for hashing a user-supplied password for a predetermined time period to render a hash result of a total number of “M” hash cycles. Means are provided for deriving a password-derived key from the result, and means encrypt a security key with the password-derived key to render an encrypted key. The system further includes means for storing the encrypted key and the number “M” of hash cycles.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting computer that can use the present invention;

FIG. 2 is flow chart of a non-limiting implementation of the present RSA key storage and protection logic; and

FIG. 3 is flow chart of a non-limiting implementation of the present RSA key recovery logic.

### DETAILED DESCRIPTION OF THE PREFERRED EMBODIMENT

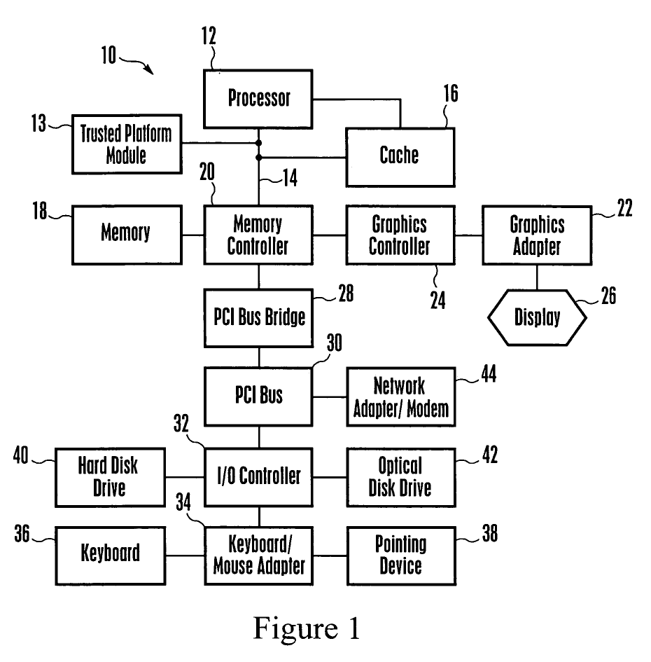

Referring initially to FIG. 1, a high-level block diagram of a data processing system, generally designated 10, is shown in which the present invention may be implemented. The system 10 in one non-limiting embodiment is a personal computer or laptop computer, and can function as the below-described recording computer and/or reading computer. The system 10 includes a processor 12, which may be, without limitation, a PowerPC processor available from International Business Machines Corporation of Armonk, N.Y. (or other processors made by, e.g., Intel or AMD and common to the industry). The system 10 may also include a trusted platform module (TPM) 13 that may be implemented by a chip, for providing security functions in accordance with TPM principles known in the art, including the encryption, using a security key, data to be stored in the system 10.

The processor 12 and TPM 13 may be connected to a processor bus 14, and a cache 16, which is used to stage data to and from the processor 12 at reduced access latency, is also connected to the processor bus 14. In non-limiting embodiments the processor 12 can access data from the cache 16 or from a system solid state memory 18 by way of a memory controller function 20. Also, the memory controller 20 is connected to a memory-mapped graphics adapter 22 by way of a graphic bus controller 24, and the graphics adapter 22 provides a connection for a monitor 26 on which the user interface of software executed within data processing system 10 is displayed.

The non-limiting memory controller 20 may also be connected to a personal computer interface (PCI) bus bridge 28, which provides an interface to a PCI bus 30. Connected to the PCI bus 30 may be an input/output (I/O) controller 32 for controlling various I/O devices, including, e.g., a keyboard/mouse adapter 34 which provides connection to a keyboard 36 and to a pointing device 38, which may be implemented by a mouse, trackball, or the like. Additionally, a hard disk drive 40 is connected to the I/O controller 32. If desired, an optical disk drive 42, such as a DVD or CD drive, can be connected to the I/O controller 32. In some implementations a network adapter 44 can be attached to the PCI bus 30 as shown for connecting the data processing system 10 to a local area network (LAN), the Internet, or both. In any case, in accordance with principles known in the art, during power-on the processor 12 executes a basic input/output system (BIOS) program that may be stored in the memory 18, to load an operating system in the hard disk drive 40 into the memory 18.

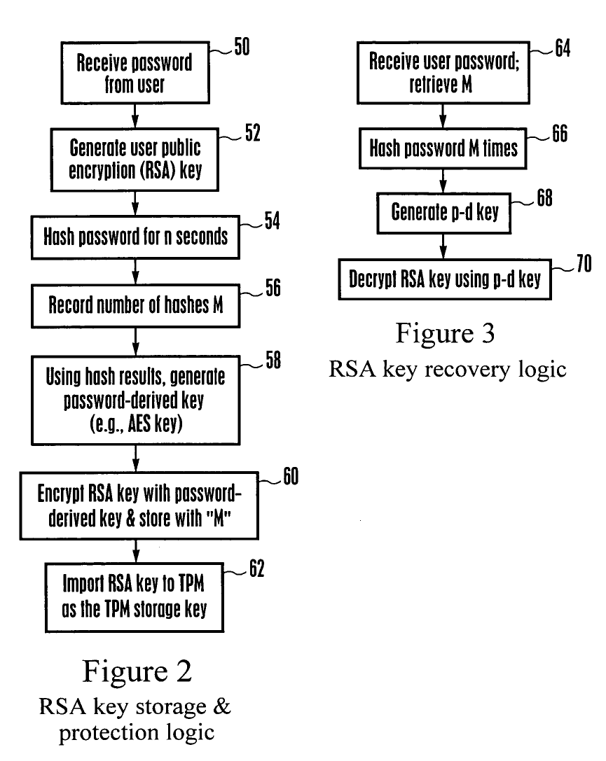

Now referring to FIG. 2, a non-limiting example of the present logic can be seen, it being understood that the logic may be implemented by any of the processors shown above or, particularly in the case of key recovery, by a processor in another computer system that may be identical to the system shown in FIG. 1. While the logic is shown in flow chart format for exposition, state coding or other types of logical coding may be used in actual implementation.

Commencing at block 50, in response to a request, a user inputs a password (which also encompasses a passphrase) which is received. In some implementations, strong password/passphrase requirements can be levied, e.g., the password, to be accepted, may be required to contain at least one letter, at least one numeral, and at least one non-alphanumeric symbol.

Proceeding to block 52, a security key is generated in accordance with principles known in the art. In one non-limiting embodiment the security key is for use by the TPM 13 to, e.g., encrypt data prior to storing it, and it may be generated in software using RSA public key cryptography principles known in the art. Thus, in the non-limiting embodiment shown the security key may be referred to as a TPM key and/or an RSA key.

Moving to block 54, the password is hashed repeatedly for “n” seconds. The value of “n”, in preferred non-limiting embodiments, is selected so that an attacker trying to perform a dictionary attack would require at least thirty days to try fifty thousand passwords. A minimum of sixty seconds is envisioned (which would mean that in one day, if sixty seconds is required for each password being tested by a hacker, at most 1,440 passwords could be tested, meaning that more than thirty days would be required to test 50,000 passwords). Because the user must wait for this processing to complete, however, the present invention understands that selecting a value of “n” that is too high results in inconvenience, as the user may believe the process has hung if made to wait too long. In any case, at the completion of the hashing step at block 54, at block 56 the total number of hash cycles “M” that were executed is recorded.

Next moving to block 58, the hash results from the step at block 54 are used to generate a password-derived key. The password-derived key may be generated using, e.g., Advanced Encryption Standard (AES) principles known in the art to generate a 256-bit AES symmetric key. Other standards may be used, e.g., triple DES. Proceeding to block 60, the security key is encrypted using the password-derived key and stored along with the number “M” of hash cycles apart from the TPM, e.g., in memory, such as the memory 18, HDD 40, etc. Then, at block 62 the security key in its unencrypted state is imported to the device that is to use it, e.g., to the TPM 13 shown in FIG. 1. When imported into the TPM 13, the security key may have the system's storage root key (SRK) as its parent. Any other user keys that may be required can then be generated with the security key as the parent key. In any case, it may now be appreciated that an attacker launching a dictionary attack against the encrypted backup copy of the security key would have to wait the minimum defined amount of time (n seconds) for each attempt to test a guessed-at password, rendering, with a sufficiently large value of “n”, a dictionary attack infeasible.

Turning to FIG. 3, a non-limiting implementation of the logic for recovering the security key from its encrypted stored version is shown. The logic in FIG. 3 may be implemented, for instance, when a user wishes to roam to another system, or if the user's normal system has had its motherboard replaced (and therefore has a new storage root key).

Commencing at block 64, the user enters the password and the number “M” of hashes is retrieved from storage. At block 66, the password is hashed “M” times using the same hashing paradigm used at block 54 in FIG. 2. Proceeding to block 68, the resulting hash is used to regenerate the password-derived key, which is used at block 70 to decrypt the security key. Of course, if the password is incorrect, the decryption of the security key will fail. The decrypted security key can then be imported to the TPM as its security key, with the system's new SRK as parent. Any other user keys are now available to the user, since they were all tied to the security key during the process shown in FIG. 2.

Accordingly, the skilled artisan can now appreciate that with the logic shown above, the only times the user encounters a delay is while the password is hashed during initial enrollment, when roaming to a new system, or when recovering after a motherboard replacement, all of which are comparatively rare activities and thus not unduly inconveniencing the user. Nonetheless, the security of the stored backup security key is maintained.

Accordingly, in non-limiting exemplary implementations, the present invention uses strong encryption keys to protect user keys that are used by a TPM, with key material of an encryption key being derived from a password provided by the user. The encryption key then encrypts the public key (RSA) material that is generated in software. Once the RSA key is encrypted and stored as a backup key, it is imported in unencrypted form into the TPM for security. The security of the encryption key is strengthened against dictionary attack by performing a series of hashes that are so time consuming that it would take an attacker an extremely long amount of time to crack, e.g., the security provided herein effectively satisfies the standard set forth in the Common Criteria Certification. Coupling this method with strong password requirements further provides for strong security of user keys that can still be relatively easily recovered or migrated with correct entry of the password.

While the particular SYSTEM AND METHOD FOR PROTECTING AGAINST DICTIONARY ATTACKS ON PASSWORD-PROTECTED TPM KEYS as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. For example, instead of a tactilely-manipulated “access” or other button on a keyboard, the present key signal can be generated when a user “manipulates” a voice recognition input device by, e.g., speaking the word “access”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A method for providing for secure storage of a security key, comprising:
performing a one-way function on a user-provided password for at least a time period to generate a result;
using the result to generate a password-derived key;
encrypting the security key with the password-derived key to render an encrypted key; and
storing the encrypted key.

2. The method of claim 1, wherein the time period is a predetermined time period having a length sufficient to render a dictionary attack to discover the password infeasible.

3. The method of claim 1, wherein the time period is at least sixty seconds.

4. The method of claim 1, wherein the security key is an RSA key.

5. The method of claim 4, wherein the password-derived key is a symmetric key.

6. The method of claim 5, further comprising storing a total number “M” of hash cycles that were executed in the performing act.

7. The method of claim 6, comprising recovering the RSA key by providing the password, retrieving the number “M” of hash cycles, hashing the password “M” times to produce the password-derived key, retrieving the encrypted key from memory and decrypting it using the password-derived key to render the RSA key.

8. The method of claim 6, comprising using the RSA key in a TPM.

9. A computer system, comprising:
at least one memory;
at least one trusted platform module (TPM), the memory not being part of the TPM; and
at least one processor executing method acts including:
performing a one-way function on a user-supplied password for at least a predetermined time period of sufficient length to render infeasible a dictionary attack on the password;
using information derived from the results of the performing act, encrypting at least one TPM key to render an encrypted key;
storing the encrypted key in the memory; and
providing the TPM key to the TPM.

10. The system of claim 9, wherein the one-way function is a hash, and the processor counts the total number “M” of hash cycles that are used to hash the user-supplied password for the predetermined time period.

11. The system of claim 9, wherein the information is AES information.

12. The system of claim 9, wherein the TPM key is an RSA key.

13. The system of claim 10, wherein to recover the TPM key from the encrypted key, the processor receives a test password and hashes it for “M” hash cycles to generate a result, and then derives information from the result useful for decrypting the encrypted key to render the TPM key, provided the test password is the same as the user-supplied password.

14. A computer system, comprising:
means for performing a one-way function on a user-supplied password for a predetermined time period to render a result of a total number of “M” function cycles;
means for deriving a password-derived key from the result;
means for encrypting a security key with the password-derived key to render an encrypted key; and
means for storing the encrypted key and the number “M” of cycles.

15. The system of claim 14, comprising means for retrieving the encrypted key and the number “M” of cycles, for use thereof in recovering the security key.

16. The system of claim 14, wherein the security key is an RSA key and the password-derived key is a symmetric key.

17. The system of claim 14, wherein the predetermined time period has a length sufficient to render a dictionary attack to discover the password infeasible.

18. The system of claim 14, wherein the security key is provided to a TPM.

19. The system of claim 15, comprising:
means communicating with the means for retrieving for hashing a test password “M” times to generate a test result;
means for processing the test result to render a test password-derived key;
means communicating with the means for retrieving for decrypting the encrypted key using the test password-derived key, the means for decrypting producing the security key only if the test password matches the user-supplied password.
